(19) United States
(12) Patent Application Publication
(10) Pub. No.: US 2016/0034483 A1
(43) Pub. Date: Feb. 4, 2016

(54) METHOD AND SYSTEM FOR DISCOVERING RELATED BOOKS BASED ON BOOK CONTENT

(71) Applicant: Kobo Incorporated, Toronto (CA)

(72) Inventors: Qingwei GE, Toronto (CA); Darius BRAZIUNAS, Toronto (CA); Jordan CHRISTENSEN, Toronto (CA)

(21) Appl. No.: 14/448,727

(22) Filed: Jul. 31, 2014

(51) Int. Cl. G06F 17/30; G06N 5/00; G06N 5/04

(52) U.S. Cl. CPC G06F 17/3097; G06F 17/30663; G06F 17/30666; G06N 5/048; G06N 5/006

(57) ABSTRACT

System and method for determining book similarities based on text content and thereby discovering related books for recommending to customer-users. Each book is associated with a probability distribution on a set of topics that is derived from text content of the book against the set of topics. The pair-wise distances of the probability distributions between corresponding books are computed to derive similarities thereof. The probability distributions may be generated by leveraging a text topic model that defines a set of topics, a respective set of relevant terms under each topic, and a probability distribution on each set of relevant terms. The text topic model may be automatically generated by processing content of a corpus of training books via a training process.

### TECHNICAL FIELD

The present disclosure relates generally to the field of e-commerce marketing, and, more specifically, to the field of automatic generation of recommendation book items.

### BACKGROUND

Presenting a recommended list of books that are related to a particular book (or reference book) has become increasingly important for e-commerce companies to effectively attract and retain consumers. Many of the recommendation systems rely on commonalities in circumstantial information to find related books, such as purchases, ratings, and feedbacks. Naturally, the circumstantial information unfortunately provides indirect, and therefore unreliable indications, of relatedness among books. Hence, the recommended books may not provide an accurate estimation on potential customers' preferences on books, for example for purchasing.

Moreover, a book item that is new or otherwise unfamiliar to a recommendation system usually has not been purchased or reviewed by customers. Thus, there is no adequate basis for a conventional recommendation system to find related books for such a book. As a result, business opportunities on the new books tend to remain stagnant.

### SUMMARY OF THE INVENTION

Therefore, it would be advantageous to provide a mechanism to automatically discover recommended books that have similar content with reference books, thereby, in the commercial context, offering enhanced marketing efficiency.

Embodiments of the present disclosure employ a computer implemented method of automatically generating a recommended or recommendation list based on content-relatedness among books. Specifically, a text topic model is automatically generated by processing content of a corpus of training books via a training process. During the training process, each training book is reduced to a bag-of-words which are aggregated into a corpus vocabulary. Stop words and most frequent words in individual books are pruned from the corpus vocabulary, e.g., in a Term Frequency-Inverse Document Frequency (TF-IDF) approach. Then a text topic model is generated based on the corpus vocabulary, e.g., in a Latent Dirichlet Allocation (LDA) approach. The resultant memory-resident model defines a set of topics, a respective set of relevant terms under each topic, and a probability distribution of each set of relevant terms. The above may be implemented as a computer process.

The text topic model is then leveraged to map content of a reference book and each candidate book into respective topic vectors by a statistical inferential method. Each resulted topic vector represents a probability distribution with respect to the set of topics derived from the content of a corresponding book against the set of topics. The relatedness between the books is then inferred from the quantified similarity between the probability distributions thereof. For instance, books with the highest relatedness with the reference book can be selected and recommended to customers.

As the book relatedness according to embodiments of the present disclosure is derived directly from book contents, the resulted recommendation books likely correlate well with the estimated user needs for exploring similar books. In the context of book selling, the marketing efficiency of the recommendation system can advantageously be enhanced. In addition, regardless of their purchase and review records, books can be equally placed in the candidate pool and processed for recommendations. Hence, even new books can be effectively promoted to potential users.

According to one embodiment of the present disclosure, a computer implemented method of automatically determining relatedness between titles comprises: (1) accessing a first probability distribution on a plurality of topics, the first probability distribution derived from a content of a first title against the plurality of topics; (2) accessing a second probability distribution on the plurality of topics, the second probability distribution derived from a content of a second title against the plurality of topics; (3) computing a similarity between the first and the second probability distributions; and (4) determining relatedness between the first and the second title based on the similarity.

The method may further comprise automatically deriving a text topic model, which comprises: accessing content of a collection of titles; representing content of each title in the collection by a set of terms and an occurrence frequency of each term in the title; generating a vocabulary of the collection of titles based on the representing; generate the plurality of topics based on the vocabulary; allocating a respective set of terms from the vocabulary under each topic of the plurality of topics; and assigning a probability value to each term under each topic of the plurality of topics. The text topic model may be derived in accordance with a Latent Dirichlet Allocation (LDA) method.

The method may further comprise: accessing the content of the first title; determining the first probability distribution in accordance with the text topic model; accessing the content of the second title; and determining the second probability distribution in accordance with the text topic model. The first probability distribution may be determined in accordance with a statistical inference method and represented by a vector specific to the first title.

In another embodiment of the present disclosure, a non-transitory computer-readable storage medium embodying instructions that, when executed by a processing device of a website, cause the processing device to perform a method of creating a recommendation list of books. The method comprises: (1) responsive to a request for discovering books related to a first book, accessing a first probability distribution with respect to a plurality of topics, wherein the first probability distribution is derived from a content of the first book against the plurality of topics; (2) identifying candidate books; (3) accessing a plurality of probability distributions with respect to the plurality of topics, wherein a respective probability distribution of the plurality of probability distributions is derived from a content of a respective candidate book; (4) computing a similarity between the first probability distribution and the respective probability distribution of the respective candidate book; and (5) presenting the respective candidate book as a book related to the first book if the similarity satisfies a predetermined similarity threshold or the book is in the list of the closest books to the first book according to the similarity.

In another embodiment of the present disclosure, a website associated system comprises a processor and a memory coupled to the processor and comprising instructions that, when executed by the processor, cause the processor to perform a method of recommending books based on relevancy to a first book. The method comprises: (1) responsive to a request for discovering books related to the first book, accessing a first probability distribution with respect to a plurality of topics, wherein the first probability distribution is derived from a content of the first book against the plurality of topics; (2) accessing a second probability distribution with respect to the plurality of topics, wherein the probability distribution is derived from a content of a second book against the plurality of topics; (3) computing a similarity between the first and the second probability distributions; and (4) presenting the second book as a book related to the first book on the website if the similarity satisfies predetermined recommendation criteria.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 is a flow chart depicting an exemplary computer implemented method of automatically generating text-based recommendations in accordance with an embodiment of the present disclosure.

FIG. 2 is a flow chart depicting an exemplary computer implemented method of automatically establishing a text topic model and deriving topic distributions from the model in accordance with an embodiment of the present disclosure.

FIG. 3 illustrates an exemplary computer implemented process of discovering text-based related books in accordance with an embodiment of the present disclosure.

FIG. 4 is a diagram illustrating an exemplary on-screen graphical user interface (GUI) that presents a recommendation list automatically generated based on content relatedness in accordance with an embodiment of the present disclosure.

FIG. 5 is a block diagram illustrating an exemplary computing system including an automatic recommendation list generator in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or client devices. When a component appears in several embodiments, the use of the same reference numeral signifies that the component is the same component as illustrated in the original embodiment.

### Method and System for Discovering Related Books Based on Book Content

Overall, provided herein are systems and methods for determining book similarities based on text content and thereby discovering related books for recommending to customers. Each book is associated with a probability distribution on a set of topics that is derived from text content of the book against the set of topics. The pair-wise distances of the probability distributions between corresponding books are computed to derive similarities thereof. The probability distributions may be generated by leveraging a text topic model that defines a set of topics, a respective set of relevant terms under each topic, and a probability distribution on each set of relevant terms. The text topic model may be automatically generated by processing content of a corpus of training books via a training process.

Although embodiments of the present disclosure are described in detail with reference to the terms of “book” and “book content,” the present disclosure is not limited by any specific form, format or language of electronic text content to be processed. A reference text content or a recommended text content can be in the form of a book, a magazine, an article, a thesis, a paper, an opinion, a statement or declaration, a piece of news, or a letter, etc. In a recommendation event, a recommended text content may or may not have the same form as the reference text content.

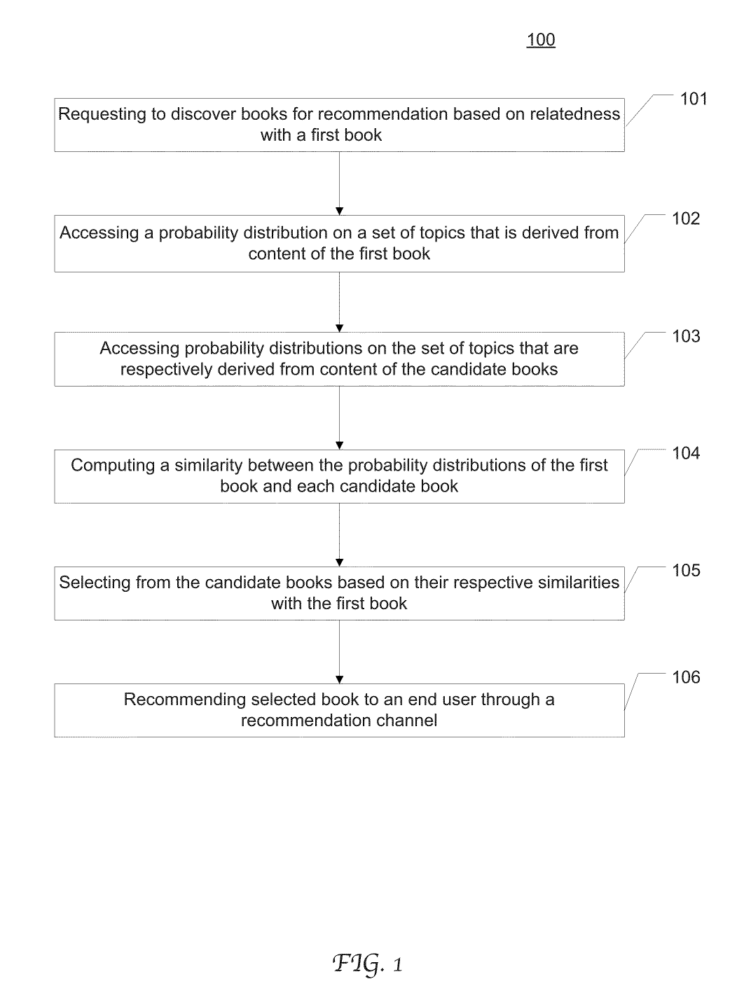

FIG. 1 is a flow chart depicting an exemplary computer implemented method 100 of automatically generating text-based recommendations in accordance with an embodiment of the present disclosure. Method 100 may be implemented on a computer system such as a server device hosted by a virtual book community, an on-line book store, a library, a publisher, and etc.

At 101, a request to discover books for recommendation based on similarities with a first book (the reference book) is received. The request may be a user request for discovering books related to the first book. Alternatively, the request may be automatically triggered following a purchase event, rating event, review event, or any other suitable event pertinent to the first book.

At 102, a topic probability distribution (or topic distribution) derived from the content of the first book is accessed, where the topic probability distribution refers to a distribution over a set of latent topics. As will be described in greater detail, the topic distribution can be derived based on a text topic model that defines the set of latent topics, and a respective distribution over the set of terms under each topic.

At 103, with each candidate book eligible for recommendation, a topic probability distribution over the same set of latent topics is accessed. Candidate books may be pre-selected from a library of books by using any suitable method that is well known in the art, for example based on category or genre tags associated with each books.

In some embodiments, because a topic distribution is derived from the content of a specific book and can only effectively represent the book if the book has sufficient word count, a minimum word count is imposed to qualify a book as a candidate. This threshold prevents from recommending books with inappropriate content based on a book with mostly pictures but few words. For example, without the threshold, some children's comic books can have some graphic adult books as their text-based related titles.

At 104, a similarity (or, inversely, the distance) between the topic distributions of the first book and each candidate book is computed. It will be appreciated that the present disclosure is not limited by any specific method of computing a similarity or distance between a pair of topic distributions. In some embodiments, each topic distribution is represented by a vector with each element corresponding to a probability value of a respective topic of the set of latent topics. Thus, the similarity between any two vectors can be calculated by using Cosine similarity, Kullback-Leibler divergence, Euclidean distance, Hellinger distance, etc., or any other suitable method that is well known in the art.

At 105, based on book content relatedness that is inferred from the quantified similarities among the topic distributions, a set of books can be selected from the candidates according to predefined recommendation criteria. In some embodiments, book relatedness to the first book may be ranked by the calculated similarities and the most related books are selected for recommendation.

At 106, the selected books are recommended to a user in a recommendation event. A recommendation list generated in accordance with the present disclosure can be presented to users through various recommendation channels, such as emails, on-line shopping websites, pop-up advertisements, electronic billboards, newspapers, electronic newspapers, magazines, and etc. Moreover, it will be appreciated that embodiments of the present disclosure are not limited to any specific manner or order of presenting the list of recommendations in a recommendation event. For instance, they can be presented simply in the order of relatedness to the reference book, or reordered based on various other metrics, such as book values, sales, user clicks, etc.

In some embodiments, the method according to the present disclosure can be combined with any other technique or process of discovering recommendation books that is known in the art, such as based on sales, user clicks, reviews, ratings, user profile information, etc.

A recommendation list that is generated based on book content relatedness can be generic and provided to all users. Alternatively, a customized recommendation list can be generated based on information specific to an individual user or a group of users sharing a same attribute. For example, the recommended books may be provided only to those who have purchased or reviewed the reference book.

According to the present disclosure, since the book relatedness is directly derived from book content, a recommended book produced thereby likely satisfies the estimated user needs for exploring similar books. Particularly in the context of book selling, the marketing efficiency of the recommendation can be enhanced. In addition, books are equally processed and placed in the candidate pool of recommendations regardless of their purchase and review records. Advantageously, even new books can be effectively promoted to potential users once processed based on the text topic model.

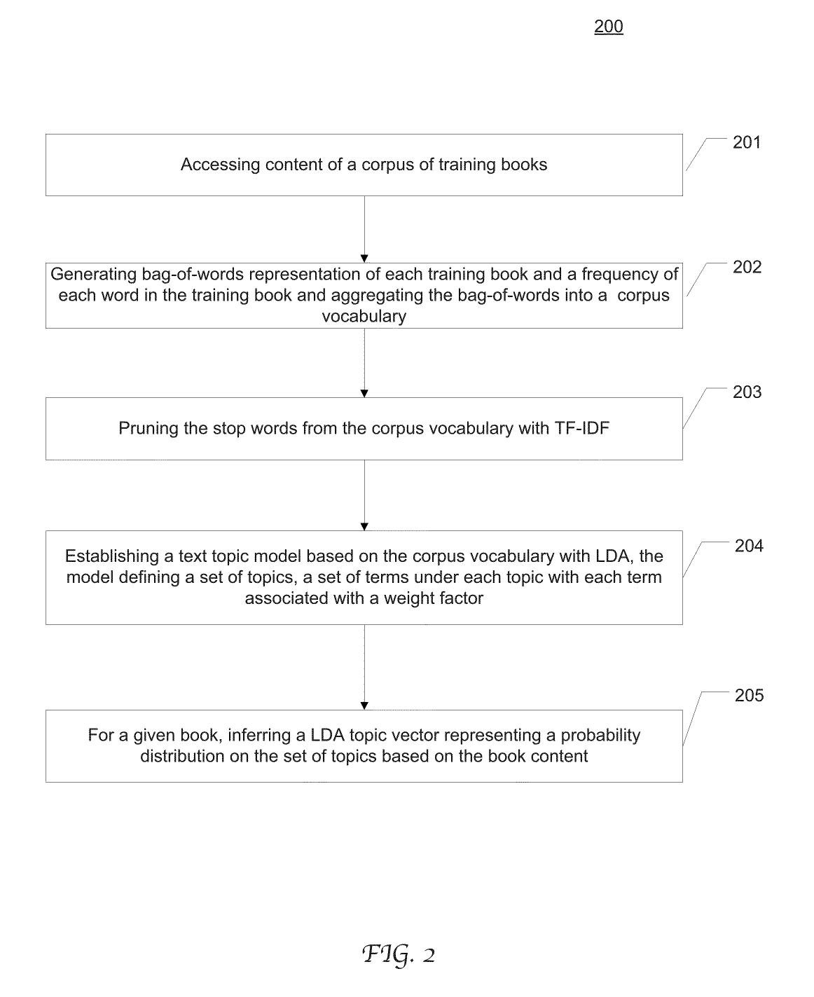

In some embodiments, a text topic model according to the present disclosure can be established through a training process by using a corpus of books. FIG. 2 is a flow chart depicting an exemplary computer implemented method 200 of automatically establishing a text topic model and deriving topic distributions from the model in accordance with an embodiment of the present disclosure. Method 200 may also be implemented on the same server device as method 100.

At 201, book content of a corpus of training books are accessed. A text content may include full text and/or abstract, and etc. At 202, each training book is reduced to a bag-of-words representation which includes a set of words and their frequencies occurring in the book. A bag-of-words representation can be generated in various techniques and processes that are well known in the art. To prevent a training process from being biased towards the most popular words in a book, a threshold frequency may be defined as a ceiling frequency and books excluded thereby. The bags-of-words are then aggregated into a corpus vocabulary.

At 203, the stop words are pruned from the corpus vocabulary, for example by using the Term Frequency-Inverse Document Frequency (TF-IDF) method in which A TF-IDF value for each word in the corpus vocabulary is calculated. Words with TF-IDF values below a preset threshold are removed from the vocabulary as stop words. Calculation of TF-IDF values can be performed in any suitable technique or method that is well known in the art.

At 204, a topic model is established through a training process (or data learning process) by using the corpus vocabulary resulted from 203. The training process can be performed in a batch mode or an online mode. The topic model can be generated in various techniques that are well known in the art, such as, Latent Dirichlet Allocation (LDA), Probabilistic Latent Semantic Indexing (PLSI), or variants thereof. A topic model can be updated by repeat foregoing 201-204, for instance, once new books are added to the library.

Table 1 shows the information represented by a partial exemplary computer memory-resident topic model that is derived from the corpus vocabulary through a LDA process in accordance with an embodiment of the present disclosure.

TABLE 1

| Topic 34 | Topic 40 | Topic 44 | Topic 45 | Topic 80 |
|---|---|---|---|---|
| vitamin | settings | teaspoon | software | syndrome |
| protein | dialog | garlic | managers | diagnosis |
| calories | tab | tablespoons | organizational | respiratory |
| diabetes | folder | flour | users | spinal |
| nutrition | app | onion | google | abdominal |

The LDA topic model identifies a set of topics based on the corpus vocabulary, e.g., Topic 1-100. As demonstrated by the selected topics presented in Table 1, each topic is associated with five relevant terms and a probability or weight distribution over the set of terms (or a term distribution). In this example, the table shows the top five most prominent terms in each topic without the associated weights or probabilities. It will be appreciated that the present disclosure is not limited to a specific number of topics or terms defined by a topic model. A topic model according to the present disclosure can be represented by using any type of machine-recognizable data structure that is well known in the art.

At 205, for a given book, e.g., a reference book or a candidate book, a topic vector can be derived from its text content based on the topic model resulted from 204. The topic vector represents a probability distribution over the set of topics identified in the topic model. A topic vector can be derived against the topic model by using various statistical inference techniques, such as Gibbs sampling and variational inference. To maintain the accuracy of an LDA model, only books with more than a certain number of words are used for training the model as well as leveraging the model.

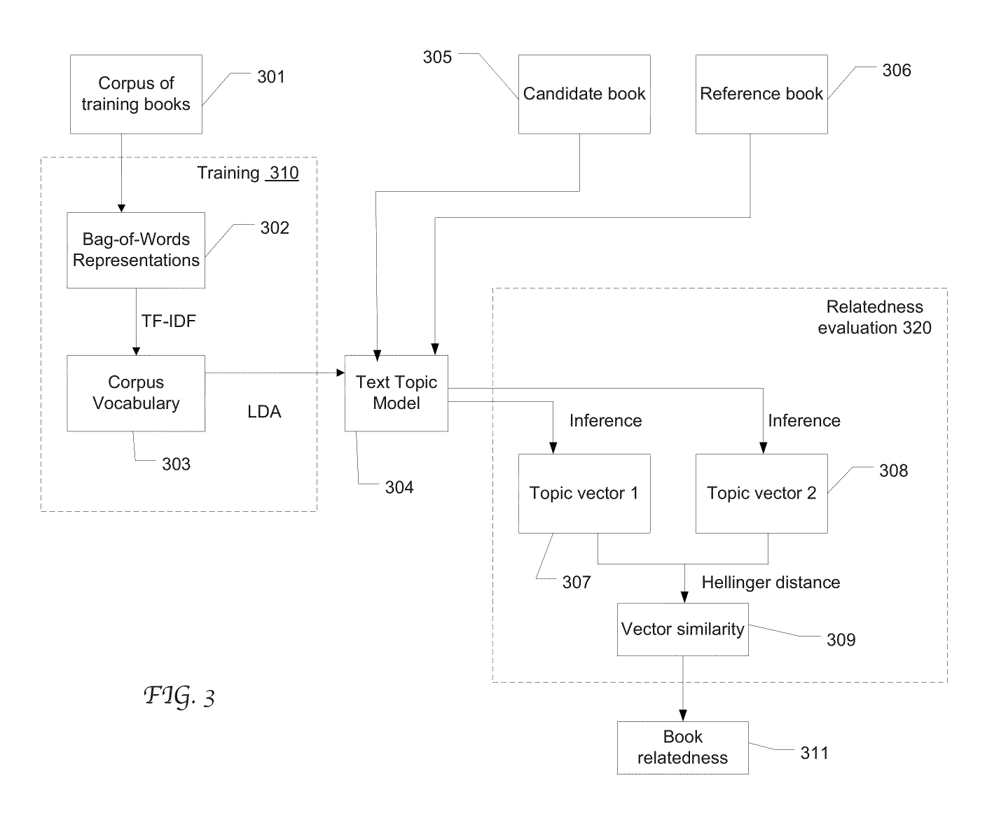

FIG. 3 illustrates an exemplary computer implemented process 300 of discovering text-based related books in accordance with an embodiment of the present disclosure. The first stage 310 of the process 300 includes obtaining a LDA topic model through a training process. The second stage 320 involves leveraging the LDA model on the books to evaluate relatedness among the books.

During the training process 310, the text contents of a corpus of training books 301 are accessed and processed. Each training book is reduced to a bag-of-words representation 302. The aggregation of bags-of-words is pruned through a TF-IDF process which removes the stop words, thereby producing the corpus vocabulary 303. Then corpus vocabulary is processed based on the LDA algorithm to obtain a text topic model 304, e.g., as depicted partially in Table 1, which is stored as a data structure in computer readable memory.

During the relatedness evaluation process 320, the content of a reference book and the candidate related books are accessed and processed based on the text topic model 304. Through a statistical inference process, a respective topic vector 306 or 307 is derived from each book (e.g., 307 or 308), which represents a probability distribution of the book over the set of latent topics defined in the topic model 304. Then, given the topic vectors of any pair of books, a vector similarity (or distance) 309 can be computed by using a Hellinger distance method. Consequently, text-content relatedness 311 of the books can be determined based on the vector similarities.

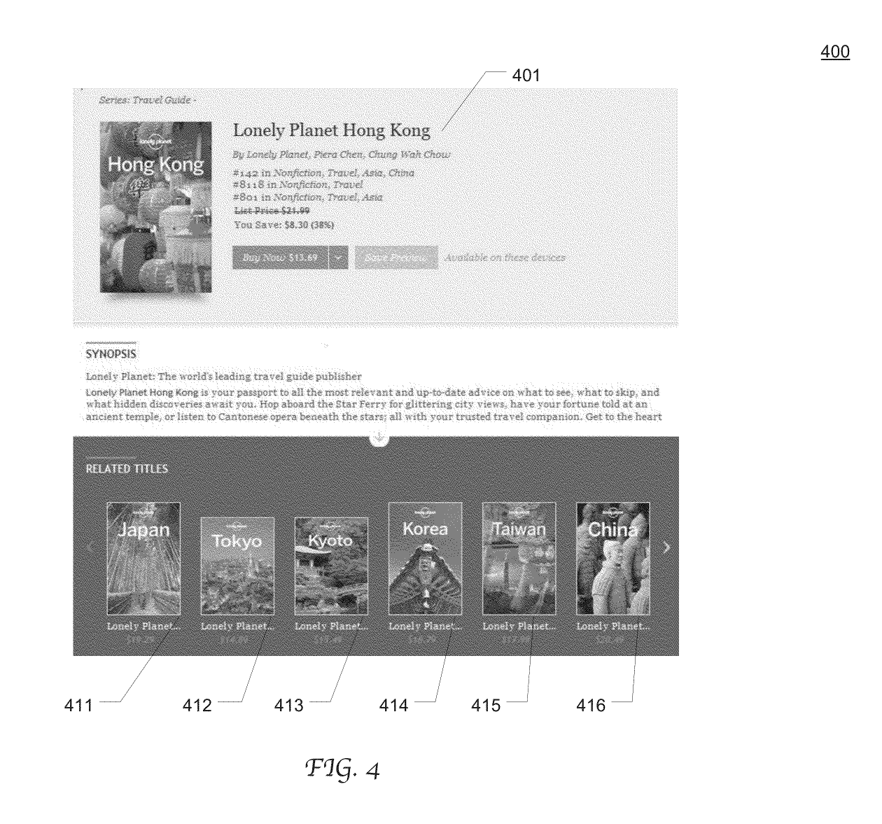

FIG. 4 is a diagram illustrating an exemplary on-screen graphical user interface (GUI) 400 that presents a recommendation list (with books 411-416) automatically generated based on content relatedness in accordance with an embodiment of the present disclosure. In this example, Lonely Planet Hong Kong 401 is the reference book. As a result of a content relatedness determination process, the books 411-416 are identified as the most related to the content of book 401. The presented recommendation list may encompass only a portion of the recommendation items resultant from a process as described with reference to FIG. 1-3. In a different recommendation event, such as a user's next visit of the on-line store, another portion of the recommendation items may be presented. The recommended books may be arranged on the GUI in any form or pattern. For example the arrangement may reflect the importance of the categories to the user. However, in some other embodiments, the books can be arranged randomly to provide diversified views to the user.

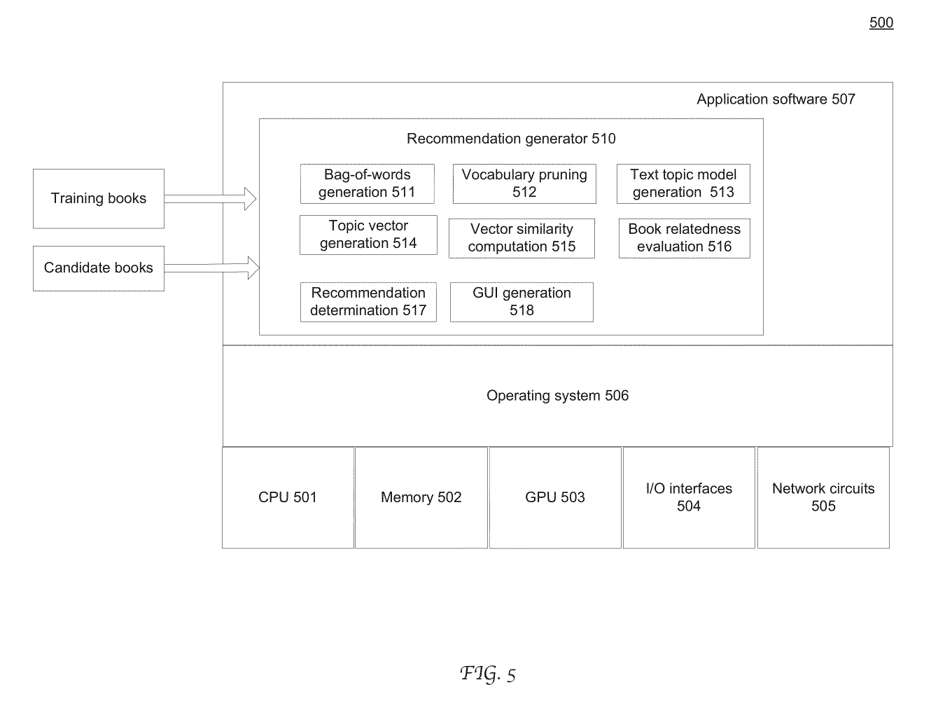

FIG. 5 is a block diagram illustrating an exemplary computing system 500 including an automatic recommendation list generator 510 in accordance with an embodiment of the present disclosure. The computing system comprises a processor 501, system memory 502, a GPU 503, I/O interfaces 504 and network circuits 505, an operating system 506 and application software 507 including the automatic recommendation list generator 510 stored in the memory 502. When incorporating programming configuration and user information collected through the Internet, and executed by the CPU 501, the automatic recommendation list generator 510 can produce recommendations in accordance with an embodiment of the present disclosure.

The recommendation generator 510 may perform various functions and processes as discussed with reference to FIG. 1-4. The automatic recommendation list generator 510 encompasses components for bag-of representation generation 511, vocabulary pruning 512, topic model generation 513, topic vector generation 514, vector similarity computation 515, book relatedness evaluation 516, recommendation determination 517 and GUI generation 518.

The bag-of-words generation 511 component can reduce each training book to a bag-of-words representation and form an aggregation of words representing the contents of the corpus. The vocabulary pruning component 512 can remove the stop words based on the TF-IDF values of all the words. The text topic model generation component 513 can perform an LDA process on the corpus vocabulary to yield a LDA topic model, as described in greater detail above.

The topic vector generation component 514 can perform a statistical inference process on the text contents of books against the LDA topic model, which yields respective topic vectors. The vector similarity computation component 515 can compute a similarity between any pair of topic vectors in according to a distance calculation method, e.g., Hellinger distance method. The book relatedness evaluation component 516 can determine the relatedness of the candidate books to a reference book based on the similarities therebetween.

The recommendation determination component 517 can generate a recommendation list based on the evaluation results, e.g., by selecting top related books. In some embodiments, the recommendation list may be modified by combining additional metrics, such as book sales, reviews, user preferences, book values, etc. The GUI generation component 518 can render to display a GUI presenting the recommendation list in part or in whole.

As will be appreciated by those with ordinary skill in the art, the automatic recommendation generator 510 may include any other suitable components and can be implemented in any one or more suitable programming languages that are known to those skilled in the art, such as C, C++, Java, Python, Perl, C#, SQL, etc.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method of automatically determining relatedness between titles, said method comprising:
accessing a first probability distribution on a plurality of topics, said first probability distribution derived from a content of a first title against said plurality of topics;
accessing a second probability distribution on said plurality of topics, said second probability distribution derived from a content of a second title against said plurality of topics;
computing a similarity between said first and said second probability distributions; and
determining relatedness between said first and said second title based on said similarity.

2. The computer implemented method of claim 1 further comprising automatically deriving a text topic model, wherein said automatically deriving comprises:
accessing content of a collection of titles;
representing content of each title in said collection by a set of terms and an occurrence frequency of each term in said title;
generating a vocabulary of said collection of titles based on said representing;
generate said plurality of topics based on said vocabulary;
allocating a respective set of terms from said vocabulary under each topic of said plurality of topics; and
assigning a probability value to each term under each topic of said plurality of topics.

3. The computer implemented method of claim 2, where said automatically deriving further comprises:
determining a term frequency (TF) and an inverse document frequency (IDF) of each term in said vocabulary; and
pruning stop words from said vocabulary based on term frequencies and inverse document frequencies of terms in said vocabulary.

4. The computer implemented method of claim 2, wherein said automatically deriving further comprises deriving said text topic model in accordance with a Latent Dirichlet Allocation (LDA) method.

5. The computer implemented method of claim 2 further comprising:
accessing said content of said first title;
determining said first probability distribution in accordance with said text topic model;
accessing said content of said second title; and
determining said second probability distribution in accordance with said text topic model.

6. The computer implemented method of claim 5, wherein said determining said first probability distribution comprises determining said first probability distribution in accordance with a statistical inference method.

7. The computer implemented method of claim 1, wherein said first probability distribution is represented by a vector specific to said first title, and wherein further each element of said vector represents a probability of said content of said first title against a respective topic of said plurality of topics.

8. The computer implemented method of claim 1 further comprising:
determining that a total count of words in said second title is greater than a preset threshold count before said accessing said second probability distribution.

9. The computer implemented method of claim 1, wherein said computing comprises computing said similarity in accordance with a Hellinger distance method.

10. A non-transitory computer-readable storage medium embodying instructions that, when executed by a processing device of a website, cause the processing device to perform a method of creating a recommendation list of books, said method comprises:
responsive to a request for discovering books related to a first book, accessing a first probability distribution with respect to a plurality of topics, wherein said first probability distribution is derived from a content of said first book against said plurality of topics;
identifying candidate books;
accessing a plurality of probability distributions with respect to said plurality of topics, wherein a respective probability distribution of said plurality of probability distributions is derived from a content of a respective candidate book;
computing a similarity between said first probability distribution and said respective probability distribution of said respective candidate book; and
presenting said respective candidate book as a book related to said first book if said similarity satisfies a predetermined similarity threshold.

11. The non-transitory computer-readable storage medium of claim 10, wherein said first probability distribution and said respective probability distribution are derived in accordance with a text topic model, wherein said text topic model defines said plurality of topics, a respective plurality of terms pertinent to each topic of said plurality of topics, and a weight distribution on said respective set of terms.

12. The non-transitory computer-readable storage medium of claim 11, wherein said method further comprises establishing said text topic model based on content of a corpus of training books, wherein said establishing comprises:
accessing content of said corpus of training books;
reducing content of each training book to a set of terms and an occurrence frequency of each of said set of terms in said training book;
generating a vocabulary of said corpus of training books based on said reducing;
generating said plurality of topics based on said vocabulary;
allocating a respective plurality of terms from said vocabulary under each of said plurality of topics; and
assigning a respective probability value to each term under each of said plurality of topics.

13. The non-transitory computer-readable storage medium of claim 11, wherein said generating said plurality of topics, said allocating and said assigning are performed in accordance with a Latent Dirichlet Allocation (LDA) method.

14. The non-transitory computer-readable storage medium of claim 11, wherein said method further comprises: generating vectors representing and said first probability distribution and said respective probability distribution in accordance with a statistical inference method.

15. The non-transitory computer-readable storage medium of claim 11, wherein said identifying said candidate books comprises verifying that a total count of words in said respective candidate book is greater than a preset threshold count.

16. The non-transitory computer-readable storage medium of claim 10, wherein said computing comprises computing said similarity in accordance with a Hellinger distance method.

17. A website associated system comprising:
a processor;
a memory coupled to said processor and comprising instructions that, when executed by said processor, cause the processor to perform a method of recommending books based on relevancy to a first book, said method comprising:
responsive to a request for discovering books related to said first book, accessing a first probability distribution with respect to a plurality of topics, wherein said first probability distribution is derived from a content of said first book against said plurality of topics;
accessing a second probability distribution with respect to said plurality of topics, wherein said probability distribution is derived from a content of a second book against said plurality of topics;
computing a similarity between said first and said second probability distributions; and
presenting said second book as a book related to said first book on said website if said similarity satisfies predetermined recommendation criteria.

18. The website associated system of claim 17, wherein said first probability and said second probability distributions are derived based on a text topic model in accordance with a Gibbs sampling and variational inference process, and wherein further said text topic model specifies said plurality of topics, a respective set of terms related to each topic, and a probability distribution associated with said respective set of terms.

19. The website associated system of claim 18, wherein said method further comprises establishing said text topic model, wherein said establishing comprises:
accessing content of a corpus of books;
reducing content of each book in said corpus by a set of terms and an occurrence frequency of each term in each book;
generating a vocabulary of said corpus of books based on said reducing;
generating said plurality of topics based on said vocabulary;
allocating a respective set of terms from said vocabulary under each topic of said plurality of topics; and
assigning a probability value to each term under each topic of said plurality of topics.

20. The website associated system of claim 19, wherein said method further comprises: removing stop words from said vocabulary in accordance with a Term Frequency-Inverse Document Frequency (IDF) method.
